(19) United States
(12) Patent Application Publication
(10) Pub. No.: US 2020/0016567 A1
(43) Pub. Date: Jan. 16, 2020

(54) HEATED DEVICE FOR ARRAY SYNTHESIS

(71) Applicant: ARIZONA BOARD OF REGENTS ON BEHALF OF ARIZONA STATE UNIVERSITY, Scottsdale, AZ (US)

(72) Inventors: Neal Woodbury, Tempe, AZ (US); Zhan-Gong Zhao, Tucson, AZ (US)

(21) Appl. No.: 16/489,099

(22) PCT Filed: Mar. 13, 2018
(86) PCT No.: PCT/US2018/022245

§ 371 Date: Aug. 27, 2019

Related U.S. Application Data
(60) Provisional application No. 62/470,835, filed on Mar. 13, 2017.

(51) Int. Cl. B01J 19/00

(52) U.S. Cl. CPC B01J 19/0046; B01J 2219/00421; B01J 2219/0049; B01J 2219/00626; B01J 2219/00536; B01J 2219/00725; B01J 2219/00495

(57) ABSTRACT

The manufacturing of molecular arrays often requires the coordination of various physical, chemical, and thermal parameters. Hence, the quality and homogeneity of many molecular arrays can be very dependent on the method of manufacturing. The instant disclosure provides a device that is configured to consistently yield peptide arrays of high quality. The device distributes optimum levels of heat and coupling solution during the chemical coupling and manufacturing of peptide array.

### CROSS-REFERENCE TO RELATED APPLICATIONS

This application claims priority to U.S. Provisional Patent Application No. 62/470,835 filed on Mar. 13, 2017, the disclosure of which is incorporated herein in its entirety by reference.

### STATEMENT AS TO FEDERALLY SPONSORED RESEARCH

This invention was made with government support under 1243082 awarded by the National Science Foundation and HSHQDC-15-C-B0008 awarded by the Department of Homeland Security. The government has certain rights in the invention.

### BACKGROUND

The manufacture of molecular arrays can be sensitive to a large number of distinct parameters, including the nature of biochemical molecules present in the array. Many methods and processes for array formation have been described in the literature, but they fail to yield large quantities of molecular arrays that consistently have high quality.

### SUMMARY

The present disclosure relates to devices and methods for manufacturing high quality molecular arrays. The device is a specialized instrument comprising a heated part that can facilitate coupling reactions of biochemical molecules onto the array. The method relates to a process for performing a chemical reaction on the surface of an array while spinning, heating, and dispensing fluids (coupling solutions) onto the array surface either continuously, semi-continuously, or occasionally.

In some cases, the disclosure provides a device for the manufacture of a molecular array, the device comprising: a) a heating component, whereby the heating component provides a level of thermal uniformity across a surface that varies by no more than 5° C. as measured from a center to an edge of the surface; b) a spinning component coupled to the heating component; whereby the spinning component distributes a continuous, a semi-continuous, or an occasional amount of a fluid comprising one or more molecular monomers, a coupling solution, or a wash solution to the surface, whereby the contemporaneous use of the heating component and the spinning component in the manufacture of the molecular array provides a homogeneous coupling of the one or more molecular monomers to at least 80% of the surface exposed to the monomer. In some embodiments, the spinning component is directly coupled or connected to the heating component. In other embodiments, the spinning component is indirectly coupled or connected to the heating component.

In some instances, the heating component provides a desired thermal uniformity across surface area of the molecular array, such as across at least 90% of the surface area, or at least 99% of the surface area of the array. The thermal uniformity may vary by no more than 1° C. between the center and the edge of the surface. In some instances, the heating component provides a desired specific heat across at least 90% of the surface, or at least 99% of the surface area of the array. The specific heat can be less than 1.05 J/g ° C. The spinning component can effectively distribute the amount of fluid comprising the one or more molecular monomers, the coupling solution, or the wash solution to at least 80%, at least 90%, or more of the surface. In some cases, the diameter of the surface is between 200 millimeters and 210 millimeters. In certain cases, the molecular monomers are amino acids. In such cases, the contemporaneous use of the heating component and the spinning component in the manufacture of the molecular array can effectively couple one or more molecular monomers to at least 90%, at least 95%, or more of the surface. In some instances, at least 90% the surface comprises an amino silane, an epoxy silane, a vinyl silane, or a silicon. In some instances, no more than 90% or no more than 99% of the surface comprises an amino silane, an epoxy silane, a vinyl silane, or a silicon. Furthermore, a device of the disclosure can comprise one or more units that store: a) the fluid comprising one or more molecular monomers; b) one or more coupling solutions; or c) one or more a wash solutions. In addition, the disclosure provides a heating component, wherein the heating unit is the heating component and a spinning component that can be used with the device described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows the mean fluorescence values obtained when the mouse anti-p53 (ab-1) monoclonal antibody, followed by a secondary anti-mouse antibody labeled with the green fluorescent dye Alexa Fluor 555, was used to probe the coupling of the RHSVV feature to a surface with a device of the disclosure.

FIG. 2 shows the mean fluorescence values obtained when the mouse anti-p53 (ab-1) monoclonal antibody, followed by a secondary anti-mouse antibody labeled with the green fluorescent dye Alexa Fluor 555, was used to probe the RHSVV feature that had been coupled for 2 minutes to: 1) different arrays in a slide; and 2) to arrays in different slides of a wafer.

FIG. 3 shows the mean fluorescence values obtained when the mouse anti-p53 (ab-1) monoclonal antibody, followed by a secondary anti-mouse antibody labeled with the green fluorescent dye Alexa Fluor 555, was used to probe the RHSVV feature that had been coupled for 3 minutes to: 1) different arrays in a slide; and 2) to arrays in different slides of a wafer.

FIG. 4 shows the mean fluorescence values obtained when the mouse anti-p53 (ab-1) monoclonal antibody, followed by a secondary anti-mouse antibody labeled with the green fluorescent dye Alexa Fluor 555, was used to probe the RHSVV feature that had been coupled for 4 minutes to: 1) different arrays in a slide; and 2) to arrays in different slides of a wafer.

FIG. 5 shows a coupling reaction conducted with a normal spin coater.

FIG. 6 depicts an example of surface damage resulting in uneven display of peptides.

FIG. 7 shows a track system with a heated chuck.

FIG. 8 shows array images from an array fabricated on track using a heated chuck.

FIG. 9 depicts a use example of arrays fabricated with a heated chuck for immunosignature analysis. Both cluster analysis and Principal Component Analysis showed good separation of infected from non-infected samples.

### DETAILED DESCRIPTION OF THE INVENTION

The disclosure provides device(s) and method(s) for manufacturing molecular arrays that use a well-designed heating component operably coupled or connected to a surface. The use of the heating component in the manufacture process can improve the uniformity of heat distribution during a chemical coupling reaction. The heating component of the device can be used contemporaneously with a spinning component to provide a desired amount of a fluid comprising one or more molecular monomers to the surface. The heating component can spin on its own, it can be mounted on a spin coater, or it can be operably coupled or connected to a surface that can spin independently of the heating component. The device can be designed to provide continuous, semi-continuous, or occasional delivery of various fluids, such as chemical coupling solutions, solutions comprising molecular monomers, and wash solutions to the surface that is coupled to the heating component. The molecular array in turn can be fabricated onto said surface. In the instances where a solution is applied to the surface during the in-situ synthesis of molecular arrays, a temperature sensitive reaction, the use of a heating component in connection with a spinning component can provide uniform distribution and coupling of the molecular compound being incorporated into the array.

In some instances, the device comprises a specialized heating component that is used to facilitate chemical reactions on a surface, such as the chemical coupling of monomers to the surface of a molecular array. The chemical reaction can be, for example, the chemical coupling of amine groups to the surface of a wafer. The device of the disclosure provides a method of performing a chemical reaction on a surface while dispensing fluids (such as coupling solutions) on the surface continuously, semi-continuously, or occasionally. In some cases the surface receiving the fluids is spinning throughout the coupling reaction while connected to the heating source.

### Device for Coupling Compounds to a Surface

The in-situ synthesis of molecular arrays sometimes requires that specific chemical reactions occur between monomers or polymers dissolved in a solution and a surface, such as the surface of a wafer. Such reactions often require heating to occur efficiently. The traditional addition of heat to the reaction with a conventional heating source could be used to catalyze the chemical coupling, however this is sometimes inefficient and uneven. An even or homogeneous coupling of monomers to a surface requires uniform application and distribution of heat across the surface. In addition, the process also requires the even distribution of monomers or polymers throughout the surface. Direct application of a solution to a surface, such as the surface of a silicon wafer with a thermal oxide coating, often results in “puddling” or the self-association of the liquid in certain regions of the surface and not in others. Puddling in turn can result in the manufacture of an array that is highly heterogeneous.

One approach to the in-situ synthesis of molecular arrays is to spin the wafer itself in an attempt to apply an even coating to the surface. However, as previously described, the coupling reaction often requires heating to occur efficiently. Thus, spinning of the wafer by itself could still lead to puddling if one needs to stop the spinning in order to heat the wafer. In addition, the volume of a coupling solution that is added to the surface of the array should be as small as possible to minimize inefficiencies and costs of manufacture, but this can render the solution more susceptible to puddling, evaporation and uneven coupling.

These problems can be overcome by manufacturing a device that can both spin and evenly heat the surface where the chemical coupling is occurring simultaneously. Such a device can be designed to receive a solution either continuously or intermittently as needed to maintain an even coating of a solution onto the surface. The device can also be designed to allow for the removal of a used solution or to allow for the replacement of a solution that is no longer needed for a particular reaction. Frequent or continuous addition of coupling solution also automatically results in effective diffusion of fresh solution to the surface, speeding up the reaction and removing unwanted reactive species.

Temperature control can be an important factor in most chemical and physical reactions. A well-designed heating component of the device can improve the temperature uniformity and homogeneity of the coupling process across an entire surface. In some cases, the heated component provides a level of thermal uniformity across a surface. The level of thermal uniformity can yield consistent coupling reactions across the surface. In some cases, the heated component can provide a temperature to a surface that varies by no more than 5° C., 4° C., 3° C., 2° C., 1° C., 0.9° C., 0.8° C., 0.7° C., 0.6° C., 0.5° C., 0.4° C., 0.3° C., 0.2° C., 0.1° C., 0.09° C., 0.08° C., 0.07° C., 0.06° C., 0.05° C., 0.04° C., 0.03° C., 0.02° C., or 0.01° C. between the center and the edge of the surface. In some cases, the heated component can provide a temperature to a surface that varies by no more than 0.1° C. between the center and the edge of the surface.

The device can be configured to provide an optimum distribution of heat and fluids across a surface, and the surface can be chemically coupled to various molecular monomers, such as amino acids, nucleic acids, linker molecules, or another suitable molecule. In some cases, the contemporaneous use of the heating component and the spinning component in the manufacture of the molecular array provides desired temperature uniformity across a surface. The average temperature uniformity across a surface can vary by no more than 5° C., no more than 4° C., no more than 3° C., no more than 2° C., no more than 1° C., no more than 0.9° C., no more than 0.8° C., no more than 0.7° C., no more than 0.6° C., no more than 0.5° C., no more than 0.4° C., no more than 0.3° C., no more than 0.2° C., no more than 0.1° C., no more than 0.09° C., no more than 0.08° C., no more than 0.07° C., no more than 0.06° C., no more than 0.05° C., no more than 0.04° C., no more than 0.03° C., no more than 0.02° C., or no more than 0.01° C. between the center and the edge of the surface.

The temperature uniformity provided across a surface for a specific material can be the average amount of heat per unit mass required to raise the temperature by one degree Celsius, for example the specific heat of water is typically defined as 1 calorie/gram ° C.=4.186 joule/gram ° C. (J/g ° C.). This heat can be described as the specific heat of the surface at constant pressure (Cₚ) or constant volume (Cᵥ). In some cases, the device can be configured to provide a C, of less than 5 J/g ° C., less than 4 J/g ° C., less than 3 J/g ° C., less than 2 J/g ° C., less than 1 J/g ° C., less than 0.24 J/g ° C., less than 0.23 J/g ° C., less than 0.22 J/g ° C., less than 0.21 J/g ° C., less than 0.20 J/g ° C., less than 0.19 J/g ° C., less than 0.18 J/g ° C., less than 0.17 J/g ° C., less than 0.16 J/g ° C., less than 0.15 J/g ° C., less than 0.14 J/g ° C., less than 0.13 J/g ° C., less than 0.12 J/g ° C., less than 0.11 J/g ° C., less than 0.10 J/g ° C., less than 0.09 J/g ° C., less than 0.08 J/g ° C., less than 0.07 J/g ° C., less than 0.06 J/g ° C., less than 0.05 J/g ° C., less than 0.04 J/g ° C., less than 0.03 J/g ° C., less than 0.02 J/g ° C., or less than 0.01 J/g ° C. to a surface. In some cases, the device can be configures to provide any of the aforementioned specific heats to at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 99% of the surface.

The device can be configured to couple monomers to a surface of in the presence of a solution with a specific viscosity. A viscosity of the fluid comprising one or more molecular monomers, the coupling solution, or the wash solution to the surface, can be dependent on the temperature applied to the array during the coupling reaction. In some cases, at room temperature, the viscosity of the fluid comprising one or more molecular monomers at the surface of the array, during the coupling reaction, i.e., the coupling solutions on the heated component can be between 1.0 mPa·s and 5.0 mPa·s, between 1.0 mPa·s and 4.0 mPa·s, between 1.0 mPa·s and 3.0 mPa·s, between 1.0 mPa·s and 2.0 mPa·s, between 1.5 mPa·s and 5.0 mPa·s, between 1.5 mPa·s and 4.0 mPa·s, between 1.5 mPa·s and 3.0 mPa·s, between 1.5 mPa·s and 2.0 mPa·s, between 2.0 mPa·s and 5.0 mPa·s, between 2.0 mPa·s and 4.0 mPa·s, between 2.0 mPa·s and 3.0 mPa·s, between 2.5 mPa·s and 5.0 mPa·s, between 2.5 mPa·s and 4.0 mPa·s, or between 2.5 mPa·s and 3.0 mPa·s. In some cases, a viscosity of the coupling solutions on the heated component can be between 1.6 mPa·s and 4.0 mPa·s.

In some cases, the contemporaneous use of the heating component and the spinning component in the manufacture of the molecular array provides a homogeneous coupling of the one or more molecular monomers to an area that is between 0% and 1%, between 1% and 5%, between 5% and 10%, between 10% and 15%, between 15% and 20%, between 20% and 25%, between 25% and 30%, between 30% and 35%, between 35% and 40%, between 40% and 45%, between 45% and 50%, between 50% and 55%, between 55% and 60%, between 60% and 65%, between 65% and 70%, between 70% and 75%, between 75% and 80%, between 80% and 85%, between 85% and 90%, between 90% and 95%, between 95% and 100%, or between 99% and 100% of the total surface area of the molecular array being manufacture on the device.

A surface of a molecular array can be flat, concave, or convex. A surface of a molecular array can be homogeneous and a surface of an array can be heterogeneous. In some embodiments, the surface of a molecular array is flat. In other embodiments, the surface is concave or round.

The device(s) and method(s) of the disclosure can be used in the manufacture of molecular arrays that are fabricated on various different types of surface (substrate) materials. A surface of a peptide array can be, for example, silicon or glass. Non-limiting examples of materials that can comprise a surface of a peptide array include glass, functionalized glass, sapphire, quartz, silicon, germanium, gallium arsenide, gallium phosphide, silicon dioxide, sodium oxide, silicon nitrade, gold, copper, nitrocellulose, nylon, polytetraflouroethylene, polyvinylidendiflouride, polystyrene, polycarbonate, polypropylene, epoxy resins, methacrylates, polyethylene terephthalate, polyethylene naphthalate or combinations thereof. In some cases, the surface of the peptide array is a silicon coated with a thermal oxide. In some cases, the heated component comprises an epoxy silane such as glycidoxypropyltrimethoxy silane, a vinyl silane such as vinyltrimethoxysilane, or a methacryloxy silane such as methacryloxypropyltrimethoxy silane.

In some instances, at least 30%, at least 40%, at least 50%, at least 60%, at least 70%, at least 80%, or at least 90% of the surface comprises a thermal oxide. In some instances, at least 30%, at least 40%, at least 50%, at least 60%, at least 70%, at least 80%, or at least 90% of the surface comprises a silicon dioxide.

In some instances, no more than 10%, no more than 20%, no more than 30%, no more than 40%, no more than 50%, no more than 60%, no more than 70%, no more than 80%, no more than 90%, or no more than 99% of the surface comprises a thermal oxide. In some instances, no more than 10%, no more than 20%, no more than 30%, no more than 40%, no more than 50%, no more than 60%, no more than 70%, no more than 80%, no more than 90%, or no more than 99% of the surface comprises a silicon dioxide.

A surface of an array can be covered with a coating during a manufacture process to provide or improve a feature. A coating can, for example, improve the adhesion capacity of a monomer to the surface. A coating can, for example, reduce background binding of a biological sample to an array of the disclosure. In some embodiments, a molecular array of the disclosure comprises a silicon wafer with a thermal oxide coating. In some embodiments, the surface of the array is coated with silicon dioxide and then with chrome, where the chrome is etched into a pattern down to the silicon dioxide. In some embodiments, the surface of the array with a coating of silicon dioxide is coated with a photoresist in a pattern and then coated with chrome in areas not covered by photoresist. After the photoresist is removed, the silicon dioxide in the pattern of the photoresist is revealed on the surface of the array. In other embodiments, the silicon dioxide on the surface of the array is etched to a desired pattern. In some cases, the pattern of silicon dioxide on the surface of the array serves as alignment marks. In some cases, the silicon dioxide on the surface of the array is coated with silanes. In some cases, the surface is further coated with an amino silane such as aminopropyltriethoxy silane or an epoxy silane such as glycidoxypropyltrimethoxy silane or a vinyl silane such as vinyltrimethoxysilane or a methacryloxy silane such as methacryloxypropyltrimethoxy silane to provide free reactive groups during the manufacture process.

A device of the disclosure can be used in the manufacture of a molecular array with varying dimensions. For instance, a device of the disclosure can be used in the manufacture of a flat, or mostly flat, peptide array measuring 8 inches in one or more dimensions. For instance, a device of the disclosure can be used in the manufacture of a flat, or mostly flat, peptide array measuring approximately 10 millimeters (mm), 20 mm, 30 mm, 40 mm, 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 420 mm, 430 mm, 440 mm, 450 mm, 460 mm, 470 mm, 480 mm, 490 mm, or 500 mm in one or more dimensions.

In some cases, a device of the disclosure can be used in the manufacture of a flat, or mostly flat, peptide array measuring approximately 10 millimeters (mm), 20 mm, 30 mm, 40 mm, 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 260 mm, 270 mm, 280 mm, 290 mm, 300 mm, 310 mm, 320 mm, 330 mm, 340 mm, 350 mm, 360 mm, 370 mm, 380 mm, 390 mm, 400 mm, 410 mm, 420 mm, 430 mm, 440 mm, 450 mm, 460 mm, 470 mm, 480 mm, 490 mm, or 500 mm in diameter.

A device of the disclosure can be used to chemically couple one or more monomers to a chemical group, such as the coupling of an amino acid to a free amine group on the surface. In some cases, the device is configured to provide an even distribution of a coupling fluid to the surface, whereby the coupling fluid can be more evenly distributed across the surface. For instance, the surface can be a wafer placed on the device and a fluid can be a coupling solution containing a reactive monomer.

A device of the disclosure can be used to chemically couple one or more monomers to a chemical group by applying select photomasks to the surface. The device can be coupled to an ultraviolet light (UV light) and a plurality of masks that selectively allow exposure of the UV light in some areas of the surface but not others. In some cases, the masks allow exposure of the UV light to an area that is between 0% and 1%, between 1% and 5%, between 5% and 10%, between 10% and 15%, between 15% and 20%, between 20% and 25%, between 25% and 30%, between 30% and 35%, between 35% and 40%, between 40% and 45%, between 45% and 50%, between 50% and 55%, between 55% and 60%, between 60% and 65%, between 65% and 70%, between 70% and 75%, between 75% and 80%, between 80% and 85%, between 85% and 90%, between 90% and 95%, between 95% and 100%, or between 99% and 100% of the total surface area of the molecular array being manufacture on the device.

In other cases, the masks allow exposure of the UV light to an area that is at least 0.01%, at least 0.05%, at least 0.1%, at least 0.5%, at least 1%, at least 2%, at least 3%, at least 4%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 99% of the total surface area of the molecular array being manufacture on the device.

In some cases, the device can be configured to comprise a heating element that is inductively coupled. In some instances, the device can be configured to perform a chemical coupling in the presence of one or more inert gases. Alternatively, the device can be configured to perform a chemical coupling in the presence of oxygen.

The device can be configured to provide an optimum distribution of heat and fluids across a surface, and the surface can be chemically coupled with various molecular monomers or other suitable molecules to provide a molecular array. Non-limiting examples of molecules include amino acid monomers, peptides, peptide-mimetics, peptide nucleic acids, proteins, recombinant proteins antibodies (monoclonal or polyclonal), antibody fragments, antigens, epitopes, carbohydrates, lipids, fatty acids, enzymes, natural products, nucleic acids (including DNA, RNA, nucleosides, nucleotides, structure analogs or combinations thereof), nutrients, receptors, and vitamins. In some cases, the device is used in the manufacture of a protein array or a molecular array consisting of linkages of peptide chains of various lengths.

A peptide can be physically tethered to a surface by a linker molecule. The N- or the C-terminus of the peptide can be attached to a linker molecule. A linker molecule can be, for example, a functional plurality or molecule present on the surface of an array, such as an imide functional group, an amine functional group, a hydroxyl functional group, a carboxyl functional group, a phosphoramidite functional group, an aldehyde functional group, and/or a sulfhydryl functional group. A linker molecule can be, for example, a polymer. In some embodiments the linker is maleimide. In some embodiments the linker is a glycine-serine-cysteine (GSC) or glycine-glycine-cysteine (GGC) linker. In some embodiments, the linker consists of a polypeptide of various lengths or compositions. In some cases the linker is polyethylene glycol of different lengths. In some cases the linker is a nucleic acid oligomer or peptide nucleic acid oligomer of different lengths. In yet other cases, the linker is hydroxymethyl benzoic acid, 4-hydroxy-2-methoxy benzaldehyde, 4-sulfamoyl benzoic acid, or other suitable for attaching a peptide to the solid substrate.

The device(s) and method(s) of the disclosure can be used in the manufacture of molecular arrays that have a desired distance between molecular components. In some cases, the molecular components are amino acid monomers and the device is used in the manufacture of an array that has a desired intra-monomer distance. In some cases, the monomer is an amino acid. An intra-amino acid distance in a molecular array is the distance between each peptide in the array. An intra-amino acid distance can contribute to an off-target binding or to an avidity of binding of a molecule to an array. An intra-amino acid difference can be about 0.5 nm, about 1 nm, about 1 nm, 1.1 nm, about 1.2 nm, about 1.3 nm, about 1.4 nm, about 1.5 nm, about 1.6 nm, about 1.7 nm, about 1.8 nm, about 1.9 nm, about 2 nm, about 2.1 nm, about 2.2 nm, about 2.3 nm, about 2.4 nm, about 2.5 nm, about 2.6 nm, about 2.7 nm, about 2.8 nm, about 2.9 nm, about 3 nm, about 3.1 nm, about 3.2 nm, about 3.3 nm, about 3.4 nm, about 3.5 nm, about 3.6 nm, about 3.7 nm, about 3.8 nm, about 3.9 nm, about 4 nm, about 4.1 nm, about 4.2 nm, about 4.3 nm, about 4.4 nm, about 4.5 nm, about 4.6 nm, about 4.7 nm, about 4.8 nm, about 4.9 nm, about 5 nm, about 5.1 nm, about 5.2 nm, about 5.3 nm, about 5.4 nm, about 5.5 nm, about 5.6 nm, about 5.7 nm, about 5.8 nm, about 5.9 nm, and/or about 6 nm. In some embodiments, the intra-amino acid distance is less than 6 nanometers (nm).

An intra-amino acid difference can be at least 0.5 nm, at least 1 nm, at least 1 nm, at least 1.1 nm, at least 1.2 nm, at least 1.3 nm, at least 1.4 nm, at least 1.5 nm, at least 1.6 nm, at least 1.7 nm, at least 1.8 nm, at least 1.9 nm, at least 2 nm, at least 2.1 nm, at least 2.2 nm, at least 2.3 nm, at least 2.4 nm, at least 2.5 nm, at least 2.6 nm, at least 2.7 nm, at least 2.8 nm, at least 2.9 nm, at least 3 nm, at least 3.1 nm, at least 3.2 nm, at least 3.3 nm, at least 3.4 nm, at least 3.5 nm, at least 3.6 nm, at least 3.7 nm, at least 3.8 nm, at least 3.9 nm, at least 4 nm, at least 4.1 nm, at least 4.2 nm, at least 4.3 nm, at least 4.4 nm, at least 4.5 nm, at least 4.6 nm, at least 4.7 nm, at least 4.8 nm, at least 4.9 nm, at least 5 nm, at least 5.1 nm, at least 5.2 nm, at least 5.3 nm, at least 5.4 nm, at least 5.5 nm, at least 5.6 nm, at least 5.7 nm, at least 5.8 nm, or at least 5.9 nm.

An intra-amino acid difference can be not more than 0.5 nm, not more than 1 nm, not more than 1 nm, not more than 1.1 nm, not more than 1.2 nm, not more than 1.3 nm, not more than 1.4 nm, not more than 1.5 nm, not more than 1.6 nm, not more than 1.7 nm, not more than 1.8 nm, not more than 1.9 nm, not more than 2 nm, not more than 2.1 nm, not more than 2.2 nm, not more than 2.3 nm, not more than 2.4 nm, not more than 2.5 nm, not more than 2.6 nm, not more than 2.7 nm, not more than 2.8 nm, not more than 2.9 nm, not more than 3 nm, not more than 3.1 nm, not more than 3.2 nm, not more than 3.3 nm, not more than 3.4 nm, not more than 3.5 nm, not more than 3.6 nm, not more than 3.7 nm, not more than 3.8 nm, not more than 3.9 nm, not more than 4 nm, not more than 4.1 nm, not more than 4.2 nm, not more than 4.3 nm, not more than 4.4 nm, not more than 4.5 nm, not more than 4.6 nm, not more than 4.7 nm, not more than 4.8 nm, not more than 4.9 nm, not more than 5 nm, not more than 5.1 nm, not more than 5.2 nm, not more than 5.3 nm, not more than 5.4 nm, not more than 5.5 nm, not more than 5.6 nm, not more than 5.7 nm, not more than 5.8 nm, not more than 5.9 nm, and/or not more than 6 nm. In some embodiments, the intra-amino acid distance is not more than 6 nanometers (nm).

An intra-amino acid difference can range from 0.5 nm to 1 nm, 0.5 nm to 2 nm, 0.5 nm to 3 nm, 0.5 nm to 3 nm, 0.5 nm to 4 nm, 0.5 nm to 5 nm, 0.5 nm to 6 nm, 1 nm to 2 nm, 1 nm to 3 nm, 1 nm to 4 nm, 1 nm to 5 nm, 1 nm to 6 nm, 2 nm to 3 nm, 2 nm to 4 nm, 2 nm to 5 nm, 2 nm to 6 nm, 3 nm to 4 nm, 3 nm to 5 nm, 3 nm to 6 nm, 4 nm to 5 nm, 4 nm to 6 nm, and/or 5 nm to 6 nm.

A molecular array can be manufactured with a device of the disclosure to comprise a number of different peptides homogenously or semi-homogeneously distributed on the array. In some embodiments, a molecular array comprises about 10 peptides, about 50 peptides, about 100 peptides, about 200 peptides, about 300 peptides, about 400 peptides, about 500 peptides, about 750 peptides, about 1000 peptides, about 1250 peptides, about 1500 peptides, about 1750 peptides, about 2,000 peptides; about 2,250 peptides; about 2,500 peptides; about 2,750 peptides; about 3,000 peptides; about 3,250 peptides; about 3,500 peptides; about 3,750 peptides; about 4,000 peptides; about 4,250 peptides; about 4,500 peptides; about 4,750 peptides; about 5,000 peptides; about 5,250 peptides; about 5,500 peptides; about 5,750 peptides; about 6,000 peptides; about 6,250 peptides; about 6,500 peptides; about 7,500 peptides; about 7,725 peptides 8,000 peptides; about 8,250 peptides; about 8,500 peptides; about 8,750 peptides; about 9,000 peptides; about 9,250 peptides; about 10,000 peptides; about 10,250 peptides; about 10,500 peptides; about 10,750 peptides; about 11,000 peptides; about 11,250 peptides; about 11,500 peptides; about 11,750 peptides; about 12,000 peptides; about 12,250 peptides; about 12,500 peptides; about 12,750 peptides; about 13,000 peptides; about 13,250 peptides; about 13,500 peptides; about 13,750 peptides; about 14,000 peptides; about 14,250 peptides; about 14,500 peptides; about 14,750 peptides; about 15,000 peptides; about 15,250 peptides; about 15,500 peptides; about 15,750 peptides; about 16,000 peptides; about 16,250 peptides; about 16,500 peptides; about 16,750 peptides; about 17,000 peptides; about 17,250 peptides; about 17,500 peptides; about 17,750 peptides; about 18,000 peptides; about 18,250 peptides; about 18,500 peptides; about 18,750 peptides; about 19,000 peptides; about 19,250 peptides; about 19,500 peptides; about 19,750 peptides; about 20,000 peptides; about 20,250 peptides; about 20,500 peptides; about 20,750 peptides; about 21,000 peptides; about 21,250 peptides; about 21,500 peptides; about 21,750 peptides; about 22,000 peptides; about 22,250 peptides; about 22,500 peptides; about 22,750 peptides; about 23,000 peptides; about 23,250 peptides; about 23,500 peptides; about 23,750 peptides; about 24,000 peptides; about 24,250 peptides; about 24,500 peptides; about 24,750 peptides; about 25,000 peptides; about 25,250 peptides; about 25,500 peptides; about 25,750 peptides; and/or about 30,000 peptides homogenously or semi-homogeneously distributed on the array.

In some embodiments the array comprise about 30,000 peptides; about 35,000 peptides; about 40,000 peptides; about 45,000 peptides; about 50,000 peptides; about 55,000 peptides; about 60,000 peptides; about 65,000 peptides; about 70,000 peptides; about 75,000 peptides; about 80,000 peptides; about 85,000 peptides; about 90,000 peptides; about 95,000 peptides; about 100,000 peptides; about 105,000 peptides; about 110,000 peptides; about 115,000 peptides; about 120,000 peptides; about 125,000 peptides; about 130,000 peptides; about 135,000 peptides; about 140,000 peptides; about 145,000 peptides; about 150,000 peptides; about 155,000 peptides; about 160,000 peptides; about 165,000 peptides; about 170,000 peptides; about 175,000 peptides; about 180,000 peptides; about 185,000 peptides; about 190,000 peptides; about 195,000 peptides; about 200,000 peptides; about 210,000 peptides; about 215,000 peptides; about 220,000 peptides; about 225,000 peptides; about 230,000 peptides; about 240,000 peptides; about 245,000 peptides; about 250,000 peptides; about 255,000 peptides; about 260,000 peptides; about 265,000 peptides; about 270,000 peptides; about 275,000 peptides; about 280,000 peptides; about 285,000 peptides; about 290,000 peptides; about 295,000 peptides; about 300,000 peptides; about 305,000 peptides; about 310,000 peptides; about 315,000 peptides; about 320,000 peptides; about 325,000 peptides; about 330,000 peptides; about 335,000 peptides; about 340,000 peptides; about 345,000 peptides; about 350,000 peptides; about 400,000 peptides; about 450,000 peptides; about 500,000 peptides; about 550,000 peptides; about 600,000 peptides; about 650,000 peptides; about 700,000 peptides; about 750,000 peptides; about 800,000 peptides; about 850,000 peptides; about 900,000 peptides; about 1,000,000 peptides; about 1,100,000 peptides; about 1,200,000 peptides; about 1,300,000 peptides; about 1,400,000 peptides; about 1,500,000 peptides; about 1,600,000 peptides; about 1,700,000 peptides; about 1,800,000 peptides; about 1,900,000 peptides; about 2,000,000 peptides; about 2,100,000 peptides; about 2,200,000 peptides; about 2,300,000 peptides; about 2,400,000 peptides; about 2,500,000 peptides; about 2,600,000 peptides; about 2,700,000 peptides; about 2,800,000 peptides; about 2,900,000 peptides; about 3,000,000 peptides; about 4,000,000 peptides; about 5,000,000 peptides; about 6,000,000 peptides; about 7,000,000 peptides; about 8,000,000 peptides; about 9,000,000 peptides; and/or about 10,000,000 peptides homogenously or semi-homogeneously distributed on the array.

In some embodiments, a peptide array comprises at least 2,000 peptides; at least 3,000 peptides; at least 4,000 peptides; at least 5,000 peptides; at least 6,000 peptides; at least 7,000 peptides; at least 8,000 peptides; at least 9,000 peptides; at least 10,000 peptides; at least 11,000 peptides; at least 12,000 peptides; at least 13,000 peptides; at least 14,000 peptides; at least 15,000 peptides; at least 16,000 peptides; at least 17,000 peptides; at least 18,000 peptides; at least 19,000 peptides; at least 20,000 peptides; at least 21,000 peptides; at least 22,000 peptides; at least 23,000 peptides; at least 24,000 peptides; at least 25,000 peptides; at least 30,000 peptides; at least 40,000 peptides; at least 50,000 peptides; at least 60,000 peptides; at least 70,000 peptides; at least 80,000 peptides; at least 90,000 peptides; at least 100,000 peptides; at least 110,000 peptides; at least 120,000 peptides; at least 130,000 peptides; at least 140,000 peptides; at least 150,000 peptides; at least 160,000 peptides; at least about 170,000 at least 180,000 peptides; at least 190,000 peptides; at least 200,000 peptides; at least 210,000 peptides; at least 220,000 peptides; at least 230,000 peptides; at least 240,000 peptides; at least 250,000 peptides; at least 260,000 peptides; at least 270,000 peptides; at least 280,000 peptides; at least 290,000 peptides; at least 300,000 peptides; at least 310,000 peptides; at least 320,000 peptides; at least 330,000 peptides; at least 340,000 peptides; at least 350,000 peptides homogenously or semi-homogeneously distributed on the array.

Molecular Arrays Manufactured with a Device of the Disclosure

A device of the disclosure can be used in the manufacture of a molecular array(s) that is optimized for immunosignaturing analysis. In some cases, an array manufactured with the methods of the disclosure is optimized to require no more than about 0.5 nl to about 50 nl, no more than about 1 nl to about 100 nl, no more than about 1 nl to about 150 nl, no more than about 1 nl to about 200 nl, no more than about 1 nl to about 250 nl, no more than about 1 nl to about 300 nl, no more than about 1 nl to about 350 nl, no more than about 1 nl to about 400 nl, no more than about 1 to about 450 nl, no more than about 5 nl to about 500 nl, no more than about 5 nl to about 550 nl, no more than about 5 nl to about 600 nl, no more than about 5 nl to about 650 nl, no more than about 5 nl to about 700 nl, no more than about 5 nl to about 750 nl, no more than about 5 nl to about 800 nl, no more than about 5 nl to about 850 nl, no more than about 5 nl to about 900 nl, no more than about 5 nl to about 950 nl, no more than about 5 nl to about 1 μl, no more than about 0.5 μl to about 1 μl, no more than about 0.5 μl to about 5 no more than about 1 μl to about 10 no more than about 1 μl to about 20 no more than about 1 μl to about 30 no more than about 1 μl to about 40 or no more than about 1 μl to about 50 μl of a whole blood, plasma, serum, lymph, or another suitable biological sample comprising one or more antibodies.

In some cases, an array manufactured with the methods of the disclosure is optimized to require no more than about 1 milliliter (ml) to about 50 no more than about 1 ml to about 100 μl, no more than about 1 ml to about 150 μl, no more than about 1 ml to about 200 μl, no more than about 1 ml to about 250 μl, no more than about 1 ml to about 300 μl, no more than about 1 ml to about 350 μl, no more than about 1 ml to about 400 μl, no more than about 1 ml to about 450 μl, no more than about 1 ml to about 500 μl, no more than about 1 ml to about 550 μl, no more than about 1 ml to about 600 μl, no more than about 1 ml to about 650 μl, no more than about 1 ml to about 700 μl, no more than about 1 ml to about 750 μl, no more than about 1 ml to about 800 μl, no more than about 1 ml to about 850 μl, no more than about 1 ml to about 900 or no more than about 1 ml to about 950 μl of a whole blood, plasma, serum, lymph, or another suitable biological sample comprising one or more antibodies.

In some cases, an array manufactured with a device of the disclosure is optimized to require at least 0.5 nl to about 50 nl, at least about 1 nl to about 100 nl, at least about 1 nl to about 150 nl, at least about 1 nl to about 200 nl, at least about 1 nl to about 250 nl, at least about 1 nl to about 300 nl, at least about 1 nl to about 350 nl, at least about 1 nl to about 400 nl, at least about 1 to about 450 nl, at least about 5 nl to about 500 nl, at least about 5 nl to about 550 nl, at least about 5 nl to about 600 nl, at least about 5 nl to about 650 nl, at least about 5 nl to about 700 nl, at least about 5 nl to about 750 nl, at least about 5 nl to about 800 nl, at least about 5 nl to about 850 nl, at least about 5 nl to about 900 nl, at least about 5 nl to about 950 nl, at least about 5 nl to about 1 μl, at least about 0.5 μl to about 1 μl, at least about 0.5 μl to about 5 μl, at least about 1 μl to about 10 μl, at least about 1 μl to about 20 μl, at least about 1 μl to about 30 μl, at least about 1 μl to about 40 μl, at least about 1 μl to about 50 μl, at least about 1 μl to about 100 μl, at least about 1 μl to about 150 μl, at least about 1 μl to about 200 μl, at least about 1 μl to about 250 μl, at least about 1 μl to about 300 μl, at least about 1 μl to about 350 μl, at least about 1 μl to about 400 μl, at least about 1 μl to about 450 μl, at least about 1 μl to about 500 μl, at least about 1 μl to about 550 μl, at least about 1 μl to about 600 μl, at least about 1 μl to about 650 μl, at least about 1 μl to about 700 μl, at least about 1 μl to about 750 μl, at least about 1 μl to about 800 μl, at least about 1 μl to about 850 μl, at least about 1 μl to about 950 μl, or at least 1 ml of a whole blood, plasma, serum, lymph, or another suitable biological sample comprising one or more antibodies.

The arrays manufactured with a device of the disclosure can have high sensitivity and specificity in immunosignaturing.

### EXAMPLES

### Example 1: Heated Spin Device for Coupling Monomer Compounds to a Surface

An 8 inch silicon wafer with a thermal oxide coating is coated with aminopropyltriethoxy silane to provide free amine groups. In a bath, Boc-protected glycine is coupled to the amines on the surface by standard methods. The wafer is then coated with a photoresist solution containing a photoacid and exposed in some places, but not others, to UV light via a specific mask. The acid removes the Boc group only in the regions exposed providing a free amine.

The wafer is subsequently placed onto a spin coater with a heated device and allowed to spin on the heated spin coater at a temperature of 85° C. A solution containing appropriate coupling components known to those familiar in the art and a second Boc-protected amino acid is then slowly but continuously added to the surface of the wafer. The solution maintains a thin but even coat of the coupling solution over the wafer for a period of about 3 minutes. The coupling solution is then replaced with a washing solution. The surface is washed. At this point a new photoresist layer can be applied and the process repeated until the desired peptides are generated in positions specified by the masks used.

### Example 2: Coupling Efficiency

To test the coupling efficiency with the heated component, epitope of p53 (Ab-1), RHSVV (SEQ ID NO. 1), was synthesized with a coupling time of 2, 3, and 4 minutes. The RHSVV (SEQ ID NO. 1) epitope was selected based on a fact that amino acids, R, H, and V, are understood to be difficult to couple to a growing peptide chain. A glycine (G) was added to the end of RHSVV epitope sequence as a linking amino acid in some experimental groups. The synthesis was conducted with an 8 inch wafer, resulting in 13 slides. Each slide contains 24 arrays, and in each array the number of experimental replicates under each coupling time is shown in Table 1:

TABLE 1

| Feature id | Coupling time | Replicates |
|---|---|---|
| RHSVV1 (SEQ ID NO. 1) | 4 min | 3074 |
| RHSVVG (SEQ ID NO. 2) | 3 min | 9429 |
| RHSVVG (SEQ ID NO. 2) | 2 min | 9440 |

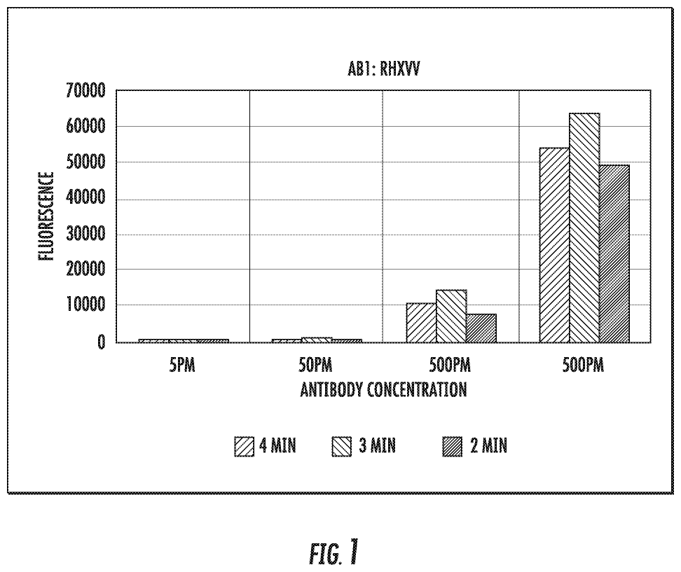

The features shown in Table 1 were probed with mouse anti p53(ab-1) monoclonal antibody, followed by a secondary anti mouse antibody labeled with a green fluorescent dye, Alexa Fluor 555. The mean fluorescent value for each of the feature ids shown in Table 1 in one slide is illustrated in FIG. 1. As shown in FIG. 1, fluorescent intensities are correlated well with concentrations of the monoclonal antibody. Differences in fluorescent intensity from features of coupled with 2, 3, or 4 minute coupling times are within experimental error.

### Example 3: Thermal Uniformity Across a Surface

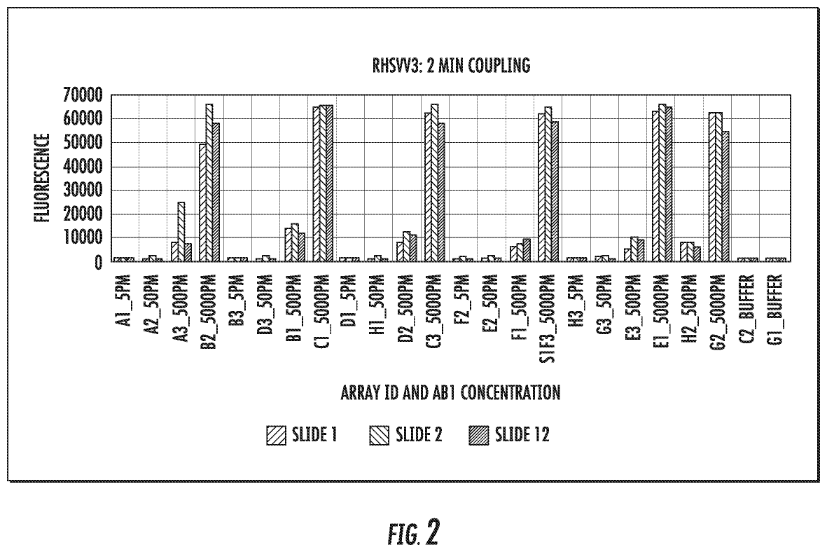

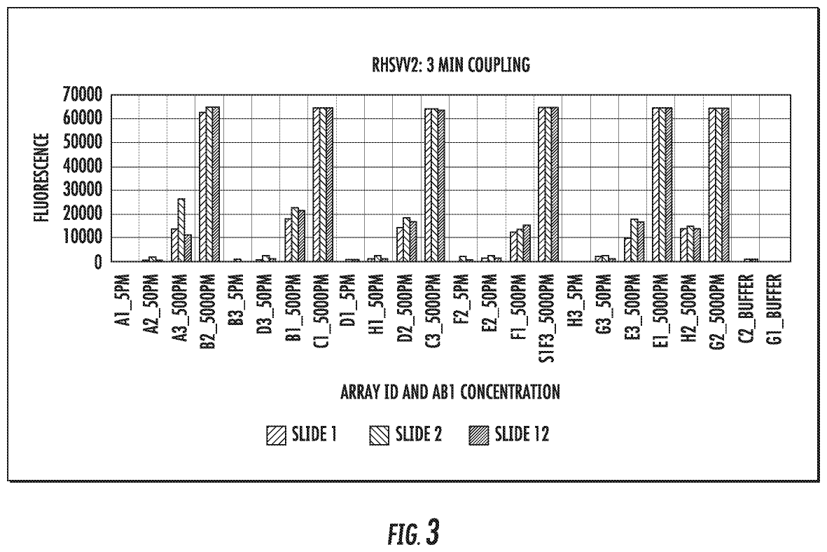

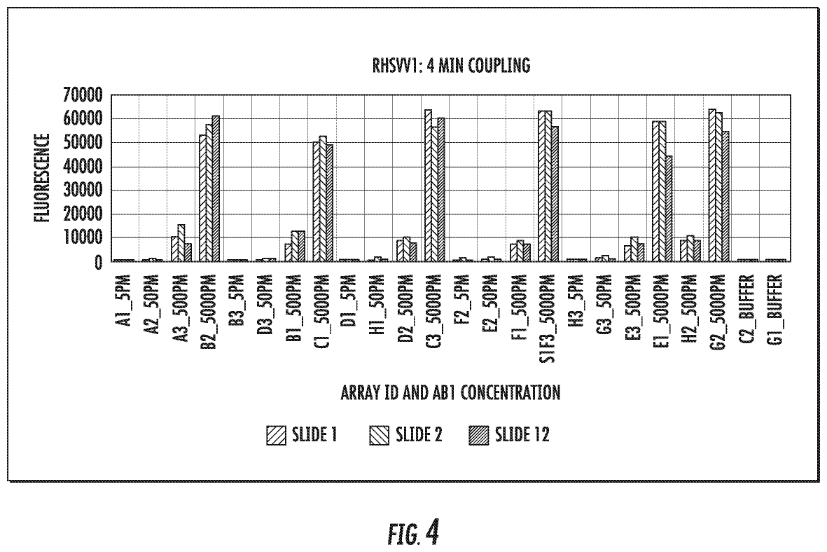

To investigate the level of thermal uniformity across a surface, i.e., heating evenness across the heated component we measured the fluorescence intensity from different arrays in a slide and from arrays in different slides of the wafer. FIGS. 2-4 show the mean fluorescence values obtained when the mouse anti-p53 (ab-1) monoclonal antibody, followed by a secondary anti-mouse antibody labeled with the green fluorescent dye Alexa Fluor 555, was used to probe the RHSVV feature that had been coupled for 2, 3, or 4 minutes to: 1) different arrays in a slide; and 2) to arrays in different slides of a wafer. These results illustrate that the heating component can provide a significantly high level of thermal uniformity across a surface and a significantly high coupling efficiency.

### Example 4: Application of a Heated Spin Coater Chuck in Wafer-Based Peptide Array Fabrication

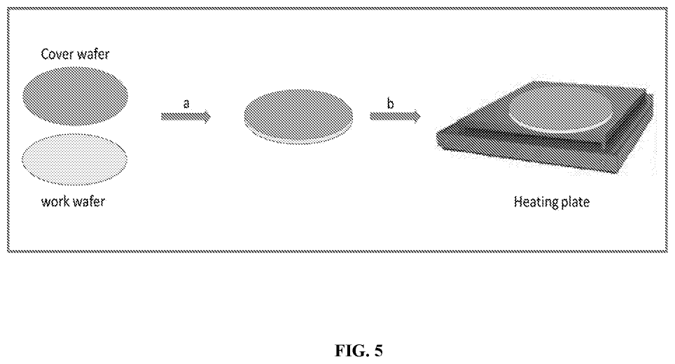

As introduced in the disclosure above, reaction of amino acid-coupling in wafer-based peptide synthesis requires heating the wafer surface to speed-up the reaction. Using a normal spin-coater in the synthesis as shown in FIG. 5, once the coupling solution is spin coated onto the wafer, a cover wafer needs to be placed onto the working wafer to prevent the solution from puddling and running off the surface. The two wafer assembly is then placed onto a heat plate for the reaction. Once the reaction is complete, the cover wafer is separated from the working wafer by sliding against each other.

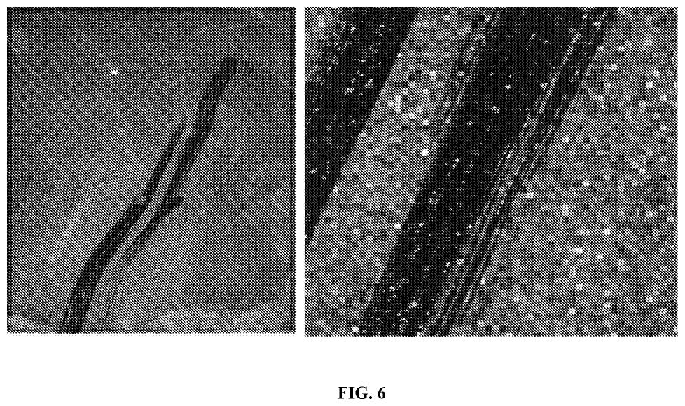

However, there may be particles (for example, dust, or, simply undissolved chemicals) in the solution. Those particles or any solid-form chemicals may damage the wafer surface during the sliding-separation step (see FIG. 6 as an example of scratches that affect the quality of an array).

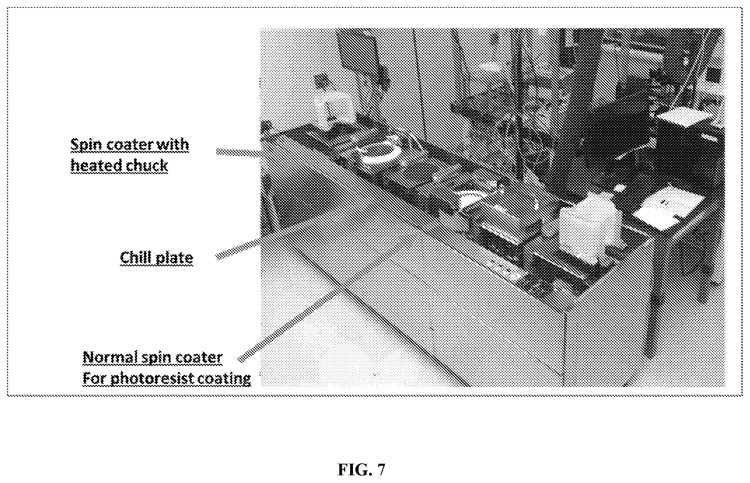

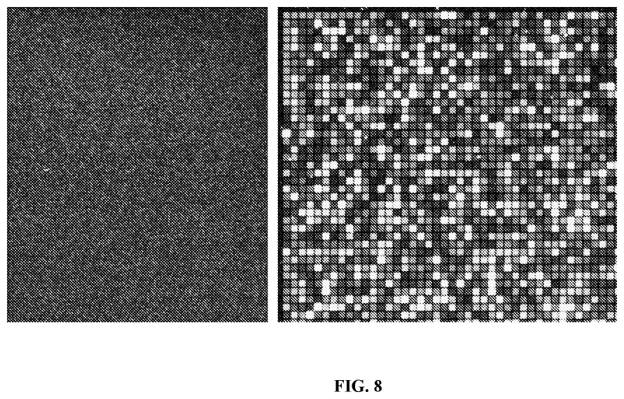

A track system that contains a spin coater with a heated chuck is depicted in FIG. 7. We have fabricated peptide arrays on a silicon wafer surface, and these arrays have been successfully used in disease profiling (e.g., in immunosignature). Surface damage observed frequently in previous works using normal spin coaters are now avoided in most of our synthesis and the quality of arrays are greatly improved. FIG. 8 shows the array image from a synthesis with heated chuck.

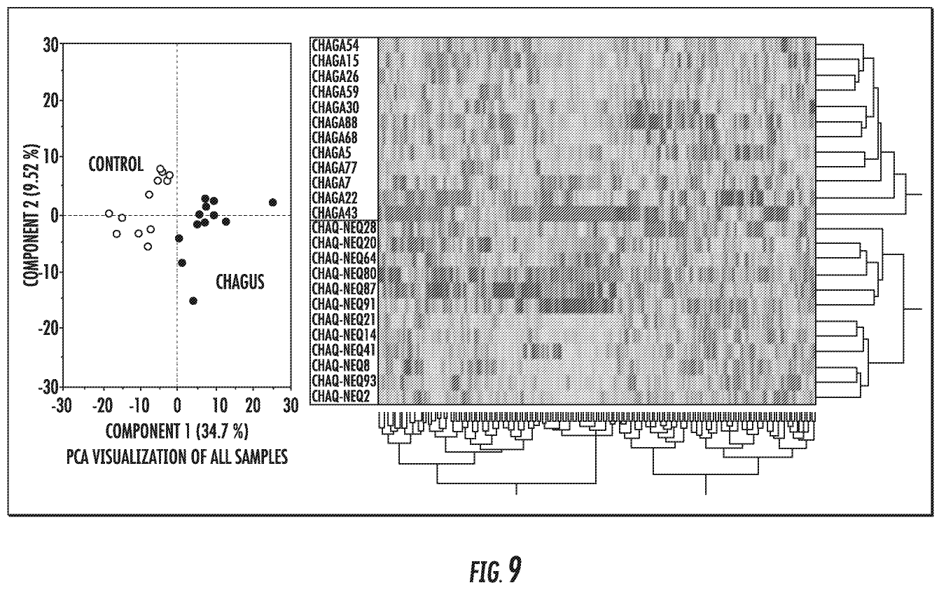

As an example, we used the arrays synthesized on track to profile and to classify blood samples infected by Chagas from samples not affected by Chagas. FIG. 9 depicts cluster and principle component analysis, both of which showed good separation of infected from non-infected samples.

While certain embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device for the manufacture of a molecular array, the device comprising:
a) a heating component, whereby the heating component provides a level of thermal uniformity across a surface that varies by no more than 5° C. as measured from a center to an edge of the surface;
b) a spinning component coupled to the heating component; whereby the spinning component distributes a continuous or a semi-continuous amount of a fluid comprising one or more molecular monomers, a coupling solution, or a wash solution to the surface,
whereby the contemporaneous use of the heating component and the spinning component in the manufacture of the molecular array provides a homogeneous coupling of the one or more molecular monomers to at least 80% of the surface exposed to the monomer.

2. The device of claim 1, wherein the heating component provides a desired thermal uniformity across at least 90% of the surface.

3. The device of claim 2, wherein the thermal uniformity varies by no more than 1° C. between the center and the edge of the surface.

4. The device of claim 1, wherein the heating component provides a desired specific heat across at least 90% of the surface.

5. The device of claim 4, wherein the specific heat is less than 1.05 J/g ° C.

6. The device of claim 1, wherein the spinning component effectively distributes the amount of fluid comprising the one or more molecular monomers, the coupling solution, or the wash solution to at least 80% of the surface.

7. The device of claim 1, wherein the spinning component distributes the amount of fluid comprising the one or more molecular monomers, the coupling solution, or the wash solution evenly to at least 90% of the surface.

8. The device of claim 1, wherein the diameter of the surface is between 200 millimeters and 210 millimeters.

9. The device of claim 1, wherein the molecular monomers are amino acids.

10. The device of claim 1, wherein the contemporaneous use of the heating component and the spinning component in the manufacture of the molecular array effectively couples one or more molecular monomers to at least 90% of the surface.

11. The device of claim 1, wherein the contemporaneous use of the heating component and the spinning component in the manufacture of the molecular array provide a homogeneous coupling of the one or more molecular monomers to at least 95% of the surface.

12. The device of claim 1, wherein at least 90% the surface comprises an amino silane, an epoxy silane, or a vinyl silane.

13. The device of claim 1, wherein at least 90% the surface comprises a thermal oxide.

14. The device of claim 1, wherein no more than 99% of the surface comprises a silicon dioxide.

15. The device of claim 1, further comprising one or more units that store: a) the fluid comprising one or more molecular monomers; b) one or more coupling solutions; or c) one or more.

16. A device for the manufacture of a molecular array, the device comprising:
a) a heating component; and
b) a spinning component coupled to the heating component; whereby the spinning component distributes a continuous or a semi-continuous amount of a fluid comprising one or more molecular monomers, a coupling solution, or a wash solution to a molecular array surface.

17. The device of claim 16, wherein the heating component provides a level of thermal uniformity across said surface that varies by no more than 5° C. as measured from a center to an edge of the surface.

18. The device of claim 16, whereby the contemporaneous use of the heating component and the spinning component in the manufacture of the molecular array provides a homogeneous coupling of the one or more molecular monomers to at least 80% of the surface exposed to the monomer.

19. A method for the manufacture of a molecular array, comprising:
a) placing an array substrate having a surface on a heating component; and
b) spinning said heating component and substrate such that a continuous or a semi-continuous amount of a fluid comprising one or more molecules, a coupling solution, or a wash solution is applied to the array substrate surface.

20. The method of claim 19, whereby contemporaneous heating and spinning provides a homogeneous coupling of the one or more molecules to at least 80% of the array substrate surface exposed to the molecules.

21. The method of claim 19, whereby the heating component provides a level of thermal uniformity across a surface of the substrate that varies by no more than 5° C. as measured from a center to an edge of the array substrate surface.


SEQUENCE LISTING (2 sequences)

SEQ ID NO: 1 - protein, 5 aa, Artificial Sequence
  p53 epitope
RHSVV

SEQ ID NO: 2 - protein, 6 aa, Artificial Sequence
  p53 epitope
RHSVVG